(19) United States
(12) Patent Application Publication
(10) Pub. No.: US 2014/0007117 A1
(43) Pub. Date: Jan. 2, 2014

(54) METHODS AND APPARATUS FOR MODIFYING SOFTWARE APPLICATIONS

(71) Applicant: BLUEBOX, San Francisco, CA (US)

(72) Inventors: Caleb Sima, San Francisco, CA (US); David Dewey, Milton, GA (US)

(21) Appl. No.: 13/916,293

(22) Filed: Jun. 12, 2013

Related U.S. Application Data
(60) Provisional application No. 61/659,048, filed on Jun. 13, 2012.

(51) Int. Cl. G06F 9/44

(52) U.S. Cl. CPC G06F 9/4421
USPC 718/102

(57) ABSTRACT

A computer-implemented method for executing a modified version of a software application in a computing system programmed to perform the method including initiating in the computing system, execution of a software application comprising an initial version of a function, wherein the initial version of the function consists of computer executable code, receiving in the computing system, a modified version of the function, wherein the modified version of the function which can be machine code, taking in human-readable configuration data and using that to direct operation, receiving in the computing system, a request to execute the function from within the software application, in response to the request to execute the function, the method includes inhibiting in the computing system, execution of the version of the function, and interpreting in the computing system, the modified version of the function to thereby execute the function.

### CROSS-REFERENCES TO RELATED APPLICATIONS

The present application is a continuation of (provisional) Application No. 61/659,048; filed on Jun. 13, 2012, the full disclosures of which is incorporated herein by reference.

### FIELD OF THE INVENTION

The present invention concerns the modification of a program in a computing system. More particularly the present invention concerns devices and methods for changing an existing program to be able to provide, to a computer, particularly mobile computing devices, a secure version of a typically small, specialized program called an application or app.

### BACKGROUND OF THE INVENTION

With the advent of small mobile electronic devices, such as mobile telephones, now called smart phones, e-tablets, including those from Apple, Microsoft, Google, Amazon and others also arrived the small-specialized programs often referred to as an Application or App for short. There are applications for almost any function that can be imagined, including games, utilities, financial programs and connectivity programs as well as fun add-ons that help to pass the time. These applications are often sold through on-line application stores that can be accessed either directly from the device or via an Internet browser, either within the device or elsewhere with connectivity to the device.

However, as with any computing system or device connected to a network and/or the Internet, these applications are potential carriers of any type of insidious programs such as viruses and tracking software, among others. Or these applications are constructed in a manner that does not adhere to secure application programming guidelines, wherein their usage may conflict with an organization's security requirements or policies. As a result many corporations and government offices that provide smart telephones or other portable electronic devices to employees and others have prohibited and in many cases through the use of administrative properties of the devices barred the devices from accepting applications. As many of these devices not only provide mobile communications and functionality but also are connected to the networks and servers of companies and government computing systems, applications having this insecurity property are a threat to the security of client data, company systems and data, government records and even national security.

It is understood that many applications provide clever functionality and are useful for business and, among other things, travel assistance, reservations, tracking of flights and analysis of data as well, boarding passes for airlines are now available through such devices, and would be helpful to the users of these devices to install and use. Further, companies that produce such useful applications for sale through the on-line and direct stores are finding that sales of these apps are compromised by the lack of security that purchasers may have when deciding to purchase the apps. This lack of security can be crippling to an application producer and can therefore have deleterious effects on commerce and the survivability of application business.

It would be desirable, therefore to offer reliable, safe and secure choices to application users and writers such that an application can be downloaded to a device without having a damaging effect on the device or the systems to which it is or maybe connected or which are otherwise prohibited due to security protocols and safety considerations.

### SUMMARY OF THE INVENTION

In accordance with the present invention, a method for executing a modified version of a software application in a computing system programmed to perform the method is provided. The steps of the method, in a preferred embodiment include, initiating the execution of a software application comprising an initial version of a function, wherein the initial version of the function consists of computer executable code and receiving a modified version of the function consisting of computer executable code, which performs operations according to a configuration file that can be comprised of human-readable characters. The method, further, includes the steps of receiving a request to execute the function from within the software application and in response to the request to execute the function inhibiting the computing system from the execution of the initial version of the function and manipulating in the computing system the modified version of the function to thereby execute the function.

It will be understood that in the method described the modified version of the function performs operations according to a configuration file. Also, the modified version can comprise machine code taking in a human-readable configuration data to direct operations. Further, the configuration file can comprise code selected from a group comprising but not limited to XML, JavaScript® and Java®. In preferred embodiments, the computing system can be selected from those used within mobile devices, a computers, mobile phones and tablet computers among others. Such devices using the following systems can be used to execute the method of the present invention, as will be known to persons having ordinary skill in the art: iOS device, an Android device and a Windows phone device.

In the method described, the inhibiting in the computing system includes finding a reference file that directs the computing system to the modified version of the function. Further, the reference file, in a preferred embodiment comprises a hook or logic library. The modified version of the function removes functionality available in the initial version of the function. However, in another embodiment the modified version of the function adds functionality unavailable in the initial version of the function. It will be understood that in the method, the initial version of the function comprises an initial value for a first parameter and the modified version of the function comprises a modified value for the first parameter.

In preferred embodiments the modified version of the function modifies functionality of the initial version of the function. In such embodiments, the modified functionality is selected from a group comprising but not limited to copy/paste restrictions, application file sharing restrictions, third party encryption support per application or per file, forcing an application to exit upon being moved from the foreground to the background, wiping data in memory, adding printing restrictions, adding authentication ability to applications, detecting “jail broken” devices, wiping data as soon as its freed, adding restrictions based upon specific location of the use, adding per application VPN or secure connection, adding per application IP address restrictions, adding or restricting accuracy to geographic location pinning and/or encryption of such data, destroying data, adding server based key encryption, adding logging into servers (all calls/get analytics), adding the ability to place multiple policies on a device and switching operation of an application based on policy triggers even when offline, adding call home and receiving new policies from remote servers, restricting debugging modes, disabling of a camera or microphone, restricting access to particular address book/Calendar (e.g. allowing a device to retrieve non-corporate calendar data only), restricting “Open In.” functionality and adding selective destroy on a per file/record basis.

In a preferred embodiment, a computing system for executing a modified version of a software application is provided. The computing system includes a memory configured to store the modified version of a software application comprising executable code, a library having a modified function, a configuration file (e.g. security policy) which in some embodiments can comprise human-readable characters and a processor coupled to the memory wherein the processor is programmed to execute the modified version of the software application such that the modified function is called. The computing system of the present invention interprets the modified function in response to the software application calling the modified function. In this computing system the library can include logic that performs operations directed by non-human readable configuration data to direct operation or human-readable configuration data without limitation.

In general, present invention relates to modification of applications. More specifically, embodiments of the present invention relate to modifying (e.g. securitizing) applications delivered to a client device. In various embodiments, the client device may be a mobile device (e.g. a phone, a tablet), a stationary computer, or the like.

Some embodiments of the present invention provide a modification (security) server disposed between a client (e.g. mobile) device and a download source for an application (e.g. an application store). In some specific embodiments, a client (e.g. mobile, desktop) device communicates with an application store (e.g. iTunes) or source via a modification (e.g. security) server. In some embodiments, a VPN, SSL or other secure connection may be established between the client device and modification server to provide such functionality

In some embodiments, the client device may be a mobile device: a portable phone, tablet computer, PDA, laptop; a stationary device: a desktop computer, a server, or the like. In some examples, the client device may be an iOS-based or OS-X device (e.g. Apple iPhone®, Apple iPad®, iMac®); an Android-based device (e.g. Samsung Galaxy®, Asus Transformer®); a Windows-based device (e.g. Windows Phone, Windows 7 or 8) (e.g. Nokia Lumina®, Samsung Slate®, desktop computer); or the like. In some embodiments, the application store may be iTunes®; Google Play® (or other Android operating system store); Windows Marketplace® (or other Windows-family (e.g. Windows Phone) operating system store); or the like.

In some embodiments, when there is an attempt to download an application on a device (e.g. by a user clicking upon a link, or the like), the modification (e.g. security) server will replace the application with a modified (e.g. securitized) version of the application. In some embodiments, the server may have a pre-stored modified version of an application, and simply provide the modified version of the application to the mobile device instead of the unmodified version of the application. In other embodiments, the server may not have stored a modified version of the application, and thus create the modified version of the application, on the fly, as will be described below. The modified version of the application will be provided to the device instead of the regular unmodified version of the application.

In some embodiments, the modified (e.g. securitized) version of the application is thus injected to the transaction between the device (e.g. mobile, desktop) and application server (e.g. application store), without either party being inconvenienced.

In some embodiments, the modified (e.g. securitized) version of an application is created by the modification (e.g. security) server, or the like, running the application; attaching a modified (e.g. securitized) library of application programming interfaces calls (APIs); and packaging the result as a modified (e.g. securitized) version of the application. In some embodiments, the modified (e.g. securitized) library of APIs may include restrictions on functions called or used by the application or any other control of the interaction of the application. Examples of this may include, restrictions upon the user saving data to particular locations (e.g. preventing the user to save a file in the mobile device memory); restrictions upon where data may be accessed from (e.g. preventing upload or download from a cloud-based storage (Dropbox®)); and the like. Other types of modifications to the application may include: copy/paste restrictions, application file sharing restrictions, third party encryption support per application or per file, forcing an application to exit upon being moved from the foreground to the background, wiping data in memory, adding printing restrictions, adding authentication ability to applications, detecting “jail broken” devices, wiping data as soon as its freed, adding restrictions based upon specific location of the use, adding per application VPN or secure connection, adding per application IP address restrictions, adding or restricting accuracy to geographic location pinning and/or encryption of such data, destroying data, adding server based key encryption, adding logging into servers (all calls/get analytics), adding the ability to place multiple policies on a device and switching operation of an application based on policy triggers even when offline, adding call home and receiving new policies from remote servers, restricting debugging modes, disabling of a camera or microphone, restricting access to particular address book/Calendar (e.g. allowing a device to retrieve non-corporate calendar data only), restricting “Open In .” functionality, adding selective destroy on a per file/record basis, and the like.

In various embodiments, the process of farming the modified version of an application (executable binary code) includes executing the initial version of the software application. The initial version typically includes a number of calls to initial or original functional libraries. In various embodiments, a hook library is provided that redirects calls to the original functional libraries to one or more new libraries provided herein. The new libraries may have additional functionality not found in the original functional libraries, may have restrictions of functionality, may restrict, set or reset certain parameters, or the like, as described above. In various embodiments, the new libraries may perform operations specified by one or more configuration files. These configuration files may include human-readable code, such as XML, Javascript®, Java®, and the like. In various embodiments, the new libraries are packaged along with the initial version of the application to fault the modified version of the application. Subsequently, when the application is executed in the user's device, instead of referencing the original functional libraries, the modified version(s) of the library(ies) are retrieved. The human-readable text stored in the one or more configuration files will specify execution (e.g. interpreted on the fly) of logic contained in the libraries. As a result, the modified version of the application can be executed.

A more detailed explanation of the invention is provided in the following description and claims and is illustrated in the accompanying drawings.

### BRIEF DESCRIPTION OF THE DRAWINGS

FIG. 1 is a representation of a system using the method of the present invention;

FIG. 2 is another representation of a system using the method of the present invention;

FIG. 3 is a flow chart of the functionality of the present invention;

FIG. 4 is a further flow chart of the functionality of the present invention;

FIG. 5 is a further flow chart of the functionality of the present invention;

FIG. 6 is a further flow chart of the functionality of the present invention; and

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

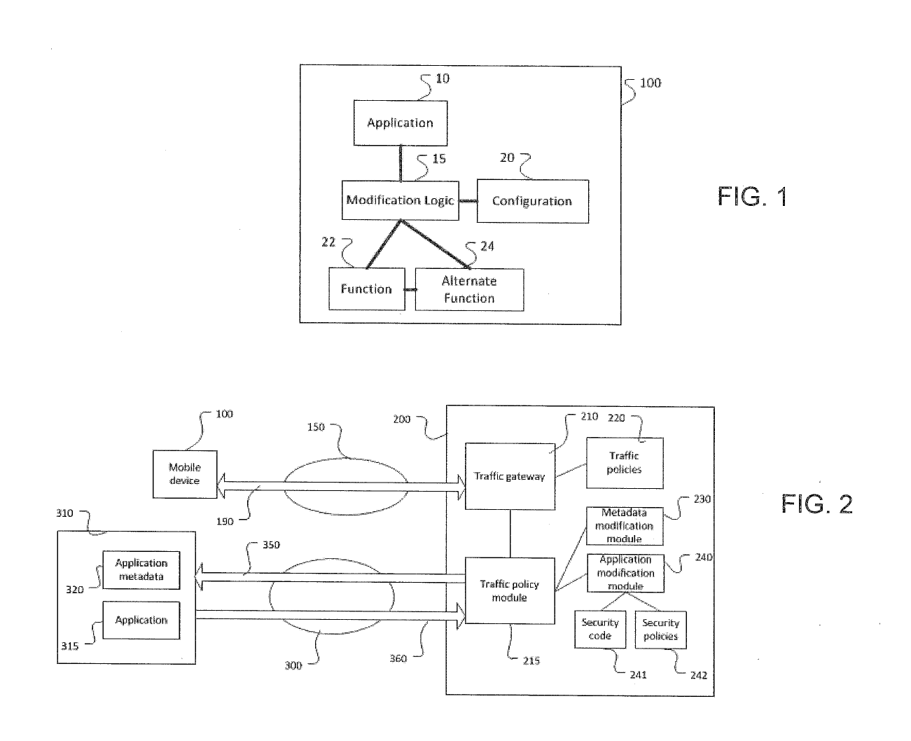

Referring to the drawings, FIG. 1 shows a mobile device 100 running a mobile application 10. At times, the application 10 may wish to invoke the function 22. It will be seen then, that the invention involves inserting logic 15 between the application 10 and the function 22. When the application 10 wishes to invoke the function 22, the modification logic 15 consults a configuration 20. The configuration 20 provides indication to modification logic 15 to inhibit the invocation of function 22 and invoke alternate function 24. This results in the application 10 invoking the alternate function 24. The logic in alternate function 24 may subsequently invoke the function 22.

Alternatively, when the application 10 wishes to invoke the function 22, the modification logic 15 will consult the configuration 20. The configuration 20 provides indication to the modification logic 15 to allow invocation of function 22. This results in the application 10 invoking the function 22.

Referring now to FIG. 2, shows a mobile device 100 connects via a communications network such as the Internet, or a cellular network, for example, to the security inspection system 200. Mobile device traffic 190 is directed to the traffic gateway 210 within the security inspection system 200. The traffic gateway 210 passes the traffic to the traffic policy module 215. The traffic policy module 215 uses policies 220 to determine an action to take on the traffic. In situations where the mobile device 100 desires to access a mobile application “app store” 310 such as Google Play®, Apple AppStore®, etc., the traffic policy module 215 sends the traffic 350 to the app store 310. The app store 310 will return requested data 360 to the traffic policy module 215; the traffic will then be returned via the traffic gateway 210 back to the mobile device 100.

When mobile device 100 desires to download an application 315 from the app store 310, the process typically involves the mobile device 100 making a request for the application metadata 320. In this system, the traffic policy module 215 will send the request 350 to the app store 310 for the application metadata 320. The application metadata 320 will be returned 360 back to the traffic policy module 215. Then the traffic policy module 215 sends the application metadata 320 to the metadata modification module 230, where the metadata may be modified. The modified metadata is provided to the traffic policy module 215, where the modified metadata is sent through traffic gateway 210 back to mobile device 100. Next, the mobile device 100 will attempt to request the application 315. In this system, the traffic policy module 215 will send the request 350 to the app store 310 for the application 315. The application 315 will be returned 360 back to the traffic policy module 215. Then the traffic policy module 215 sends the application 315 to the application modification module 240, where the application will be modified to include/add into the application security code 241 and security policies 242. The modified application is provided to the traffic policy module 215, where the modified application is sent through traffic gateway 210 back to mobile device 100.

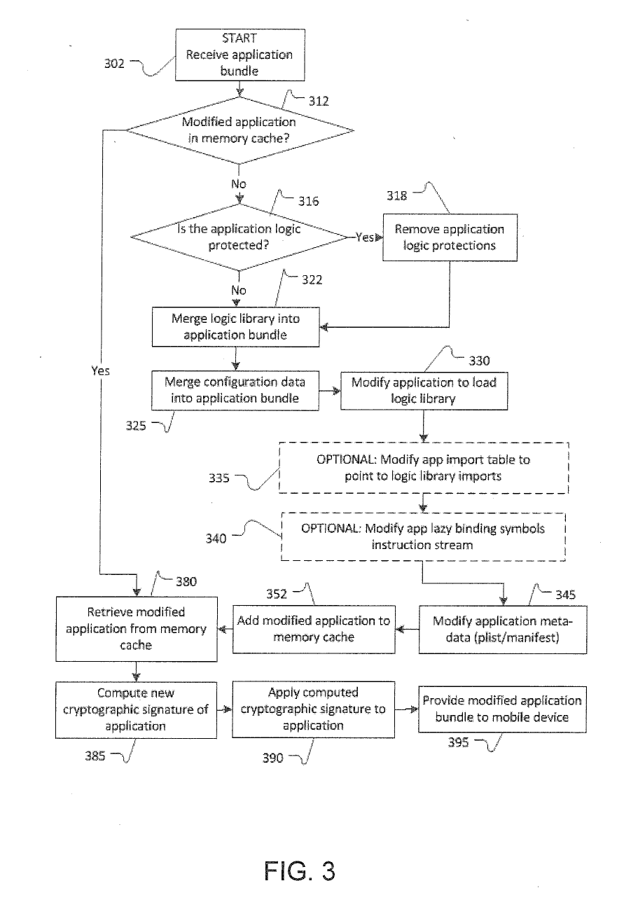

FIG. 3 is a flow chart of a preferred process of the modification aspects of the present invention. It will be understood that the elements of the flow chart, FIG. 3 and the remaining figures, come from the elements illustrated and explained above with respect to FIG. 1, where necessary the elements of FIG. 1 will be noted in the description of the flow charts. It will be understood that other elements can be substituted by persons having ordinary skill in the art without departing from the novel scope of the present invention.

As illustrated, the flow chart of FIG. 3 shows the steps and considerations for inserting the logic library, containing invention logic and alternate functions, into the desired unsecured application. It will be seen that the application server 302 receives an application bundle and then determines 312 if there is a previously modified version of the application available in the memory cache 322 of the server 302. If a modified application is available, that application is retrieved 380 from memory cache 320 and a new cryptographic signature is computed 385 and applied 390 to the application. The modified application bundle is then provided 395 to the mobile device 100. If no counterpart modified application exists in memory, a determination 316 is made as to whether the application logic is protected and if so, the protection is removed 318. Once the protection is removed 318 or if it is found not to exist, the computing system 390 merges 322 the logic library 312 and merges 325 the configuration data into the application bundle to create the modified application, which is then loaded 330 into the logic library 312. The application meta data is then modified 345 and added to the memory cache 352 so that it can be retrieved 380, as noted above. It will be understood that optionally, the app import table can be modified 335 to point to the logic library imports and that the app lazy binding symbols instruction stream can be modified 340 prior to modifying 345 the application meta-data. With the newly created modified app in memory cache 322, a new cryptographic signature is computed 385 and applied 390 to the modified app. The modified application bundle is then provided 395 to the mobile device 100.

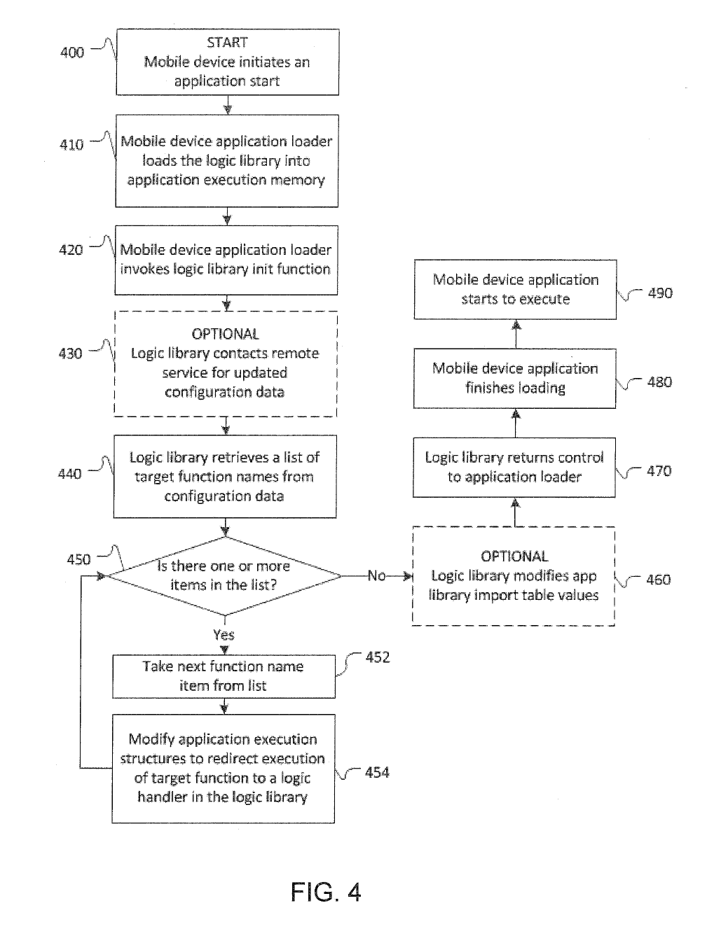

The flow chart of FIG. 4, shows the mobile application startup and the installation of the “hooks” to cause redirection of a function invocation, as will be explained herein. Referring to FIG. 4, the mobile device 100 is caused to initiate 400 the application start; wherein the application loader of the mobile device 100 loads 410 the logic library into the application execution memory. The mobile device 100 application loader then invokes 420 the logic library initiation function, wherein the logic library retrieves 440 a list of target function names from configuration data stored therein. Optionally, it will be understood that upon invocation of the logic library function, the device can be programmed to contact 430 a remote service for updated configuration data. The mobile device 100 then determines 450 if there is one or more items in the list.

If there are more than one item in the list, the system then takes 452 the next function name item from the list and the application execution structures are modified 454 to redirect the execution of target function to a logic handler in the logic library (e.g. “hooking” the target function). The mobile device 100 then returns to make the same determination 450 until there are no more items on the list. The logic library then returns 470 control to the application loader and the mobile device application finishes loading 480 and begins to execute 490. It will be understood that, optionally, once it is determined 450 that there are no more items in the list, the logic library can modify 460 the app library import table values prior to returning 470 control to the application loader.

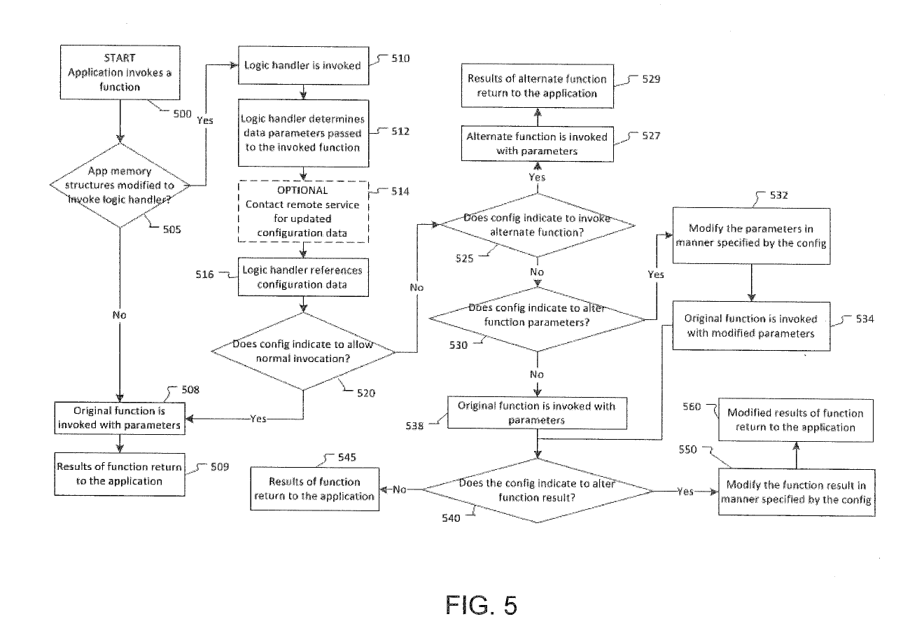

The flow chart of FIG. 5 shows the operations performed by the logic that was previously merged into the application and initialized upon the startup of the application. Referring now to FIG. 5, when a mobile device application invokes 500 a function, the system first determines 505 if the application memory structures were modified to invoke logic handler in the logic library. If it is determined 505 that this modification did not occur, the original application function is invoked 508 with parameters and the results of function are returned 509 to the application. If however, it is determined 505 that the application memory structures were modified to invoke logic handler then the logic handler is invoked 510 and it determines 512 the data parameters passed to the invoked function. Optionally, here, the mobile device system can contact 514 a remote service to secure updated configuration data as needed. Thereupon, the logic handler references 516 the configuration table.

Continuing in FIG. 5, the logic handler then queries 520 whether the configuration data indicates to allow normal invocation. If the configuration data query indicates to allow normal invocation (e.g. query response “yes”), the original function is invoked 508 and the result of the function is returned 509 to the application; if the query response is “no”, a second query is asked 525, does the configuration data indicate to invoke an alternate function? If the configuration data query indicates to invoke an alternate function (e.g. query response “yes”), the alternate function is invoked 527 and the results of the alternate function are returned 529 to the application. If the query response is “no”, a third query 530 is reached—whether the configuration data indicates to alter function parameters? If the configuration data query indicates to not alter the function parameters (e.g. query response “no”), the original function is invoked 538 with parameters and a final query 540 is reached, if the query response is “yes”, the parameters are modified 532 in the manner specified in the configuration data and the original function is invoked 534 with the modified parameters and the final query 540 is reached. Finally, the system queries whether the configuration data indicates 540 to alter the function results? If the query response is “no”, the results of the function are returned 545 to the application and if “yes”, the function results are modified 550 in a manner specified by the configuration data and the modified results are returned 560 to the application.

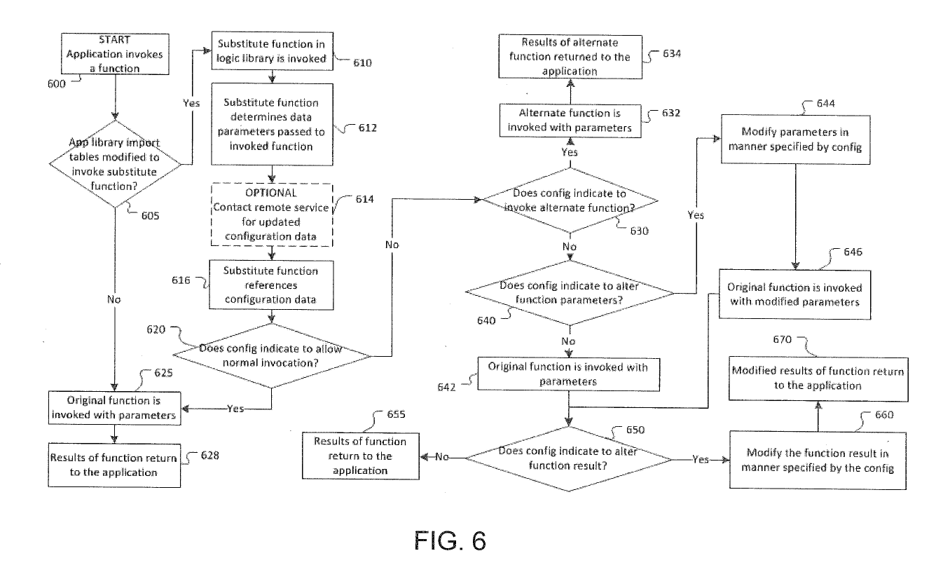

FIG. 6 is a flow chart of the operations performed by the logic that was previously merged into the application and initialized upon the application starting. It will be understood by persons having ordinary skill in the art that the difference between the flow chart of FIG. 6 and the flow chart of FIG. 5 is that one global handler is established that can handle varying invocations for different functions (i.e. a many to one relationship). The flow chart of FIG. 5 accounts for the “modify to invoke a logic handler” block in the flow chart of FIG. 4. For the flow chart of FIG. 6, a unique substitute function is specified for each invocation target, i.e. a one to one relationship. This accounts for the “modify the app library import table” block in the flow chart of FIG. 4.

Referring now to FIG. 6, the application invokes 600 a function and queries the application library import table for the target function to invoke. If the application library import table for the target function was not previously modified by the logic library initialization logic, the original function of the application is invoked 625 with parameters and the results of the function are returned 628 to the application. If the application library import table for the target function was modified to invoke a substitute function, a substitute function in logic library is invoked 610 and determines 612 the data parameters passed to the invoked function. Optionally, a remote service can be here contacted 614 for updated configuration data. The substitute function reference 616 configuration data and if the configuration data indicates to allow normal invocation the original function is invoked 625 and the results are returned 628 to the application. If normal invocation is not allowed 630, a query regarding whether the configuration data indicates to invoke 630 alternate functions; if “yes” an alternate function is invoked 632 with parameters and the results are returned 634 to the application. If the configuration data does invoke alternate functions, another query is presented as whether the configuration data indicates 640 to alter function parameters.

Continuing in FIG. 6, if a query to the configuration data does not indicate an alteration 640 of the function parameters (e.g. query response “no”), then the original function is invoked 642 with parameters. If the query response is “yes”, the parameters are modified 644 in the manner specified by the configuration data and the original function is invoked 646 with the modified parameters. This then brings the final query, whether the configuration data indicates to alter the function results? If “no”, the results of the function are returned 645 to the application and if “yes”, the function results are modified 650 in a manner specified by the config and the modified results are returned 670 to the application.

One example of an overview of system including embodiments of the present invention is illustrated below. In this illustration, the client device (e.g. desktop, mobile device) is located on the left side of the image, the “proxy” is the redirection (e.g. modification) server, and the “app store” is a source for the application. The following is a real world-type example of the system broadly shown in FIG. 2:

1. A VPN or secure connection, or unsecure connection is established between a mobile or stationary device and a security modification server. It will be understood that in some embodiments, the device may be a phone, tablet computer, PDA, laptop, computer, or the like and the security server may be associated with a company, organization, or the like.

2. A user using a mobile device connects to an application store via the VPN and the security server. The application store may be iTunes®, Google Play® or other Android® operating system store, Windows Marketplace® or other Windows-family e.g. Windows Phone operating system store.

3. The user selects an application from the application store for download via the VPN and security server.

4. The application store provides a meta-data of the application for download to the security server.

5. The security server determines a modified meta-data for a securitized version of the application.

6. The security server provides the modified meta-data to the mobile device via the VPN.

7. The mobile device provides the modified meta-data and a request for the binary executable of the application to the security server via the VPN.

8. The security server provides the meta-data and a request for the binary executable for the application to the application store.

9. The application store sends and the security server receives the binary executable for the application.

10. The security server determines a securitized version of the application.

11. The security server sends the securitized version of the application to the mobile device via the VPN. In one example, the following computer code may be used to provide the securitized version of the application.

12. The mobile device reviews the securitized version of the application and compares the computed meta-data to the modified meta-data provided in step 6.

13. When computed meta-data and modified meta-data match, the securitized version of the application is installed onto the mobile device.

In some embodiments of step 10, the following steps may be performed by the security server to determine a securitized version of the application:

1. Check memory to determine if a securitized version of the application has already been formed. If so, the securitized version of the application is provided to the mobile device.

2. If not, the security server unpacks and runs the binary code of the application.

3. Next, a securitized library of functions is provided, and the binary code of the application and the securitized library of functions are repacked to form a securitized version of the application.

In some embodiments, meta-data may not be used to authenticate the download of an application. Accordingly, in such embodiments, the steps related to meta-data, described above, are not performed.

In other embodiments, combinations or sub-combinations of the above-disclosed invention can be advantageously made. The block diagram of the architecture and the flow chart are grouped for ease of understanding. However it should be understood that combinations of blocks, additions of new blocks, re-arrangement of blocks, and the like are contemplated in alternative embodiments of the present invention.

As an example, in one embodiment, a user is coupled to a portable computer, desktop computer, or the like and attempts to download an application to their computer for their mobile device. In such an embodiment, the computer may again be coupled to the security server via a VPN to the application store. Similar to the above, when an application is being requested, the security server may intercept the response from the application store, and automatically provide the securitized version of the application back to the computer. Later, when the user synchronizes their mobile device to the computer, the securitized version of the application maybe provided to the mobile device.

Although an illustrative embodiment of the invention has been shown and described, it is to be understood that various modifications and substitutions may be made by those skilled in the art without departing from the novel spirit and scope of the invention.

What is claimed is:

1. A method for executing a modified version of a software application in a computing system programmed to perform the method comprising the steps of:
initiating the execution of a software application comprising an initial version of a function, wherein the initial version of the function consists of computer executable code;
receiving a modified version of the function;
receiving a request to execute the function from within the software application and in response to the request to execute the function;
inhibiting in the computing system the execution of the initial version of the function; and
manipulating the modified version of the function to thereby execute the function.

2. The method of claim 1 wherein the modified version of the function comprises computer executable code capable of performing operations directed by a configuration file

3. The method of claim 1 wherein the modified version of the function comprises machine code taking in human-readable configuration data to direct operation.

4. The method of claim 2 wherein the configuration file contains data from a group comprising but not limited to XML, Javascript and Java.

5. The method of claim 1 wherein the computing system is selected from a group comprising but not limited to a mobile device, a computer, a phone and a tablet computer.

6. The method of claim 5 wherein the mobile device is selected from a group comprising but not limited to an iOS device, an Android device and a Windows phone device.

7. The method of claim 1 wherein the inhibiting in the computing system includes finding a reference file that directs the computing system to the modified version of the function.

8. The method of claim 7 wherein the reference file comprises a logic library.

9. The method of claim 1 wherein the modified version of the function removes functionality available in the initial version of the function.

10. The method of claim 1 wherein the modified version of the function adds functionality unavailable in the initial version of the function.

11. The method of claim 1 wherein the initial version of the function comprises an initial value for a first parameter and the modified version of the function comprises a modified value for the first parameter.

12. The method of claim 1 wherein the modified version of the function modifies functionality of the initial version of the function and wherein the modified functionality is selected from a group comprising but not limited to copy/paste restrictions, application file sharing restrictions, third party encryption support per application or per file, forcing an application to exit upon being moved from the foreground to the background, wiping data in memory, adding printing restrictions, adding authentication ability to applications, detecting “jail broken” devices, wiping data as soon as its freed, adding restrictions based upon specific location of the use, adding per application VPN or secure connection, adding per application IP address restrictions, adding or restricting accuracy to geographic location pinning and/or encryption of such data, destroying data, adding server based key encryption, adding logging into servers (all calls/get analytics), adding the ability to place multiple policies on a device and switching operation of an application based on policy triggers even when offline, adding call home and receiving new policies from remote servers, restricting debugging modes, disabling of a camera or microphone, restricting access to particular address book/Calendar (e.g. allowing a device to retrieve non-corporate calendar data only), restricting “Open In.” functionality and adding selective destroy on a per file/record basis.

13. A computing system for executing a modified version of a software application comprising:
a memory configured to store the modified version of a software application comprising executable code;
a library having a modified function;
a processor coupled to the memory wherein the processor is programmed to execute the modified version of the software application such that the modified function is called; and
wherein the computing system interprets the modified function in response to the software application calling the modified function.

14. The computing system of claim 13 wherein the library can include logic that performs operations directed by non-human readable configuration data to direct operations.

15. The computing system of claim 13 wherein the library can include logic that performs operations directed by configuration data that comprises machine code taking in human-readable configuration data to direct operations.
